(19) United States
(12) Patent Application Publication
(10) Pub. No.: US 2010/0218973 A1
(43) Pub. Date: Sep. 2, 2010

(54) SEPARATOR FOR COMMUNICATION CABLE WITH GEOMETRIC FEATURES

(76) Inventors: David P. Camp, II, Florence, KY (US); Robert D. Kenny, Cincinnati, OH (US); Scott M. BROWN, Independence, KY (US)

Correspondence Address: BLANK ROME LLP, WATERGATE, 600 NEW HAMPSHIRE AVENUE, N.W., WASHINGTON, DC, 20037, US

(21) Appl. No.: 12/695,594

(22) Filed: Jan. 28, 2010

Related U.S. Application Data
(60) Provisional application No. 61/148,507, filed on Jan. 30, 2009.

(51) Int. Cl. H01B 11/02; H01B 7/00

(52) U.S. Cl. 174/113 C; 174/135

(57) ABSTRACT

A separator for a communication cable that has a body including at least one segment adapted to define at least first and second quadrants in the communication cable for separating wires. The at least one segment has at least one part with a first width. The at least one segment includes at least one geometric feature spaced from a terminal end of the segment. The geometric feature has a geometric shape defines a discrete portion of the segment. The geometric feature has a second width larger than the first width, whereby the difference between the first and second widths represents at least one reduced area of the body.

### RELATED APPLICATION

This application claims priority to U.S. Provisional Application No. 61/148,507, filed on Jan. 30, 2009, the subject matter of which is hereby incorporated by reference.

### FIELD OF THE INVENTION

invention relates to a separator for a communication cable. More specifically, the separator of the present invention includes geometric features for separating the wire pairs of the communication cable.

### BACKGROUND OF THE INVENTION

Conventional data cables, which typically transmit digital information, employ a plurality of twisted wire pairs. To satisfy high speed digital requirements, the data cables must transmit data at high frequencies, typically to 500 Mhz. With high frequencies, however, interference or near end crosstalk often occurs due to electromagnetic coupling between the twisted pairs within the cable. Such interference degrades the performance of the cable.

To reduce interference and improve performance, the twisted pairs of the data cable are often twisted with very short lay lengths and/or a filler is added to physically increase the distance between the wire pairs. For example, as seen in FIG. 1, a conventional cable 100 includes a jacket 110 supporting a plurality of twisted wire pairs 120 and a standard star filler 130. The star filler 130 is thick and uniform to provide the necessary physical separation between the pairs 120. Alternatively, the twisted wire pairs of the cable may be individually shielded from one another. All of these options, however, are costly, and often do not provide optimum flame performance and dielectric properties.

### SUMMARY OF THE INVENTION

Accordingly, an exemplary embodiment of the present invention teaches a separator for a communication cable that has a body including at least one segment adapted to define at least first and second quadrants in the communication cable for separating wires. The at least one segment has at least one part with a first width. The at least one segment includes at least one geometric feature spaced from a terminal end of the segment. The geometric feature has a geometric shape defines a discrete portion of the segment. The geometric feature has a second width larger than the first width of the segment, whereby the difference between the first and second widths represents at least one reduced area of the body.

Another exemplary embodiment of the present invention teaches a separator for a communication cable that has a body that includes a plurality of segments adapted to define a plurality of quadrants in the communication cable for separating wires. Each of the segments has a terminal end. The segments meet at a junction point of the body. Each of the plurality of segments has at least one geometric feature. Each of the geometric features is located between the junction point of the body and the terminal end of each of the segments. The geometric features have a geometric shape that defines a discrete portion of each of the segments to form at least one reduced area of said body.

Yet another exemplary embodiment of the present invention teaches a communication cable that includes a jacket and a separator received in the jacket. The separator includes a body that has a plurality of segments adapted to define a plurality of quadrants within the jacket. Each of the segments has a terminal end. The segments are substantially perpendicular with respect to one another and meet at a junction point of the body. At least one geometric feature is located between the terminal end of each of the segments and the junction point of the body. Each of the geometric features has a geometric shape that defines a discrete portion of each of the segments to form at least one reduced area of the body wherein at least one geometric feature extends into each of the quadrants. At least one wire pair is supported in each of the quadrants.

Still another exemplary embodiment of the present invention teaches a communication cable that comprises a jacket and a separator received in the jacket. The separator includes a body that has at least one segment adapted to define at least first and second quadrants in the communication cable for separating wires. The at least one segment has at least one part with a first width. The at least one segment includes at least one geometric feature spaced from a terminal end of the segment. The geometric feature has a geometric shape that defines a discrete portion of the segment. The geometric feature has a second width that is larger than the first width of the segment, whereby the difference between the first and second widths represents at least one reduced area of the body. At least one wire pair is supported in each of the first and second quadrants.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross sectional view of a prior art cable separator;

FIG. 2A is a cross sectional view of a cable including a separator according to a first exemplary embodiment of the present invention;

FIG. 2B is an enlarged cross sectional view of the separator illustrated in FIG. 2A;

FIG. 2C is a cross sectional view similar to FIG. 2A, showing the prior art filler of FIG. 1 in dashed lines and overlaid on the separator of FIG. 2A;

FIG. 3 is a cross sectional view of a cable including a separator according to a second exemplary embodiment of the present invention; and

FIG. 4 is a cross-sectional view of a cable including a separator according to a third exemplary embodiment of the present invention.

### DETAILED DESCRIPTION OF THE INVENTION

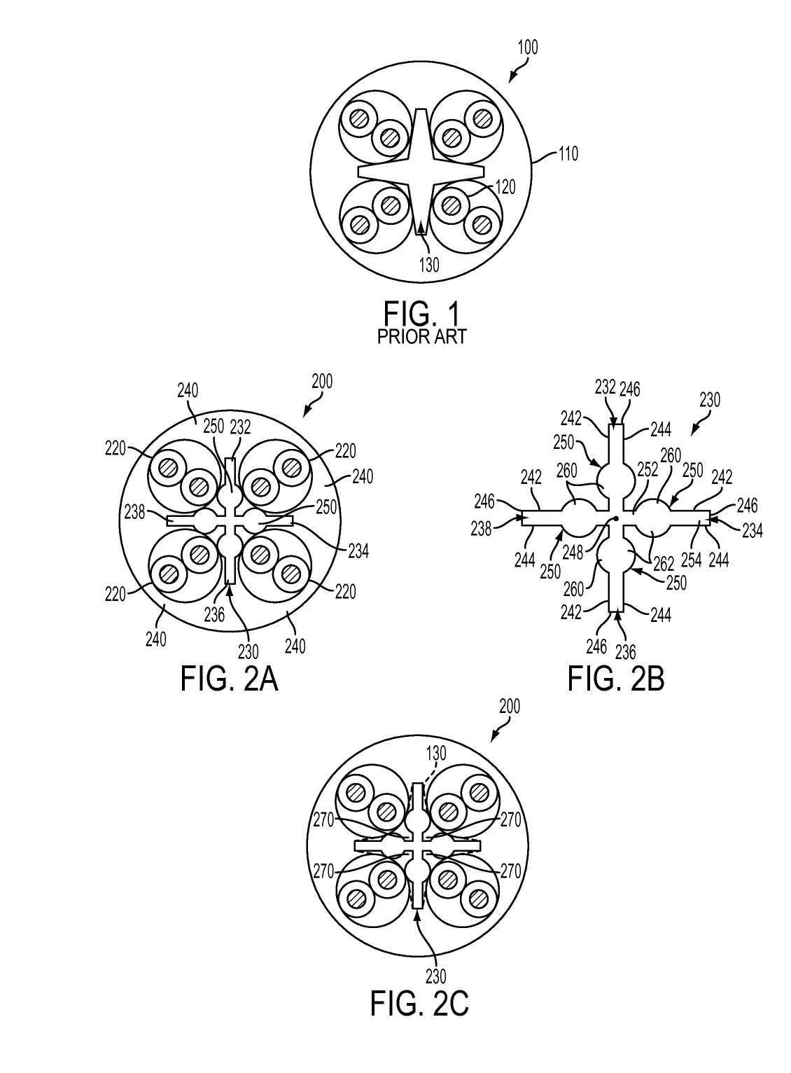

Referring to FIGS. 2A-2C, a cable 200 according to an exemplary embodiment of the invention has a jacket 210 supporting a plurality of twisted wire pairs 220 and a separator 230. The separator 230 extends longitudinally within the cable 200 to separate the wire pairs 220. The separator 230 is preferably made of a plastic material, such as fluorinated ethylene propylene (FEP), polyethylene (PE) and polyvinyl chloride (PVC). The separator 230, by introducing discrete geometric features 250, reduces crosstalk interference between the pairs 220 while also improving the smoke and flame performance of the cable and improving the dielectric properties of the cable.

As seen in FIGS. 2A and 2B, the separator 230 is preferably thinner than the prior art separator 130 of FIG. 1 and, unlike the prior art separator 130, is preferably non-uniform. The separator 230 may be a one-piece body that forms a cross-web with first, second, third and fourth segments 232, 234, 236, and 238. The segments 232, 234, 236, and 238 form generally four quadrants 240 within the cable 200. The separator 230 may be, however, separate pieces attached together and may have any number of segments, including a single segment. Each segment 232, 234, 236, and 238 has opposing surfaces 242 and 244 and a terminal end 246 remote from the junction 248 of the segments.

Each segment 232, 234, 236, and 238 preferably incorporates a geometric feature 250 which is formed as a discrete portion of the respective segment and located between the terminal end 246 of the segment and the junction 248 of the separator. That is, the geometric features 250 are spaced from the segments' terminal end 246 and generally divide the segments into first and second parts 252 and 254 (see FIG. 2B). The first and second parts 252 and 254 have generally the same thickness or width whereas the geometric features 250 have an increased width. In other words, the first and second parts 252 and 254 each have a first width and each of the geometric features 250 have a second width that is larger than the first width.

Each geometric feature 250 is preferably a rib member that extends from both surfaces 242 and 244 of its respective segment. For example, the geometric features 250 of FIG. 2B may include first and second rib members 260 and 262 extending from opposite segment surfaces 242 and 244. The rib members 260 and 262 may be rounded ribs such that the geometric feature has a generally circular cross-sectional shape. Alternatively, geometric features 250 may extend from only one of the surfaces 242 and 244 of each segment. That is, one of first and second rib members 260 and 262 would extend from one of the surfaces 242 and 244 of the respective segment.

FIG. 2C illustrates the prior art star filler 130 of FIG. 1 in dashed lines overlaid on the separator 230, thereby showing the reduced areas 270 that are created by incorporating the geometric features 250 in the separator 230. Those reduced areas 270 represent the reduction of material needed in the conventional separators to separate the wire pairs 220 which reduces manufacturing costs. In general, the reduced areas 270 (and the material savings) are represented by the difference between the thickness or width of the individual segments, such as the first width of parts 252 and 254, and the width of the geometric features 250. Additionally, less material means less combustible material, thereby improving the smoke and flame performance of the cable 200. Also, the reduced areas 270 introduce more air into the cable 200, thereby improving its dielectric properties.

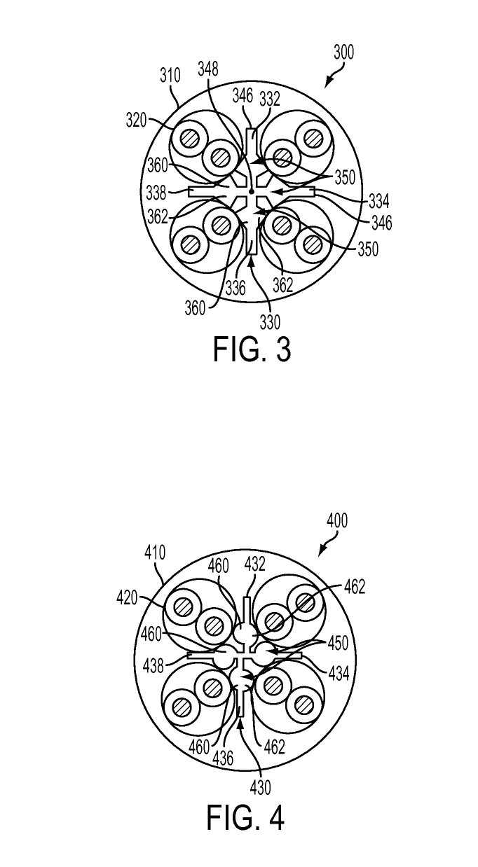

FIG. 3 illustrates a cable 300 of a second exemplary embodiment according to the present invention which includes a jacket 310, wire pairs 320, and a separator 330. The separator 330 is substantially the same as the separator 230 of the first embodiment, except its geometric features 350 have a substantially pointed or triangular shape instead of a rounded shape. As with the first embodiment, the rib members 360 and 362 of the geometric features 350 may extend from both surfaces of a respective segment 332, 334, 336, and 338 of the separator, thereby forming a generally diamond cross-sectional shape. And similar to the geometric features 250 of the first embodiment, the geometric features 350 are preferably located between the terminal ends 346 of the respective segments and the junction 348 of the segments.

FIG. 4 illustrates a cable 400 of a third exemplary embodiment according to the present invention which includes a jacket 410, wire pairs 420, and a separator 430. The separator 430 is similar to the separator 230 of the first embodiment, except that its segments are offset with respect to one another. More particularly, the separator 430 may include any number of segments, and preferably includes four segments 432, 434, 436, and 438, wherein one of the segments, such as segment 436, is offset from the other segments. By offsetting at least one segment 436, a more problematic wire pair 420 may be spaced further away from the remaining wire pairs. That is, as is known in the art, a wire pair with longer lay lengths typically causes more interference problems than a wire pair that is tightly twisted or has short lay lengths. Offsetting the segment 436 allows strategic placement of the wire pairs 420 within the cable 400. FIG. 4 also illustrates that the rib members 460 and 462 of the geometric features 450 may be offset from one another with some rib members being closer to the center 448 of the separator 430 than the other rib members. As with the first and second embodiments, the geometric features 450 may extend from both surfaces of the segments or from only one surface. For example, only rib members 460 can be employed, instead of both rib members 460 and 462.

While particular embodiments have been chosen to illustrate the invention, it will be understood by those skilled in the art that various changes and modifications can be made therein without departing from the scope of the invention as defined in the appended claims. For example, the geometric features can have any geometric shape. For example, in addition to a rounded or pointed/triangular shape, the rib members may be squared off or beveled. Also, the geometric features may have any cross-sectional shape. For example, in addition to a circular or diamond shape, the geometric features may also be square, rectangular, trapezoidal, or the like in cross-sectional shape.

What is claimed is:

1. A separator for a communication cable, comprising:
a body including,
at least one segment adapted to define at least first and second quadrants in the communication cable for separating wires, said at least one segment having at least one part with a first width, and
said at least one segment including at least one geometric feature spaced from a terminal end of said segment, said geometric feature having a geometric shape defining a discrete portion of said segment, said geometric feature having a second width larger than said first width of said segment, whereby the difference between said first and second widths represents at least one reduced area of said body.

2. A separator according to claim 1, wherein
said geometric feature is a rib member extending from at least one surface of said segment.

3. A separator according to claim 2, wherein
a second geometric feature extends from a second surface opposite said at least one surface.

4. A separator according to claim 3, wherein
said second geometric feature extending from said second surface being offset from geometric feature extending from at least one surface.

5. A separator according to claim 2, wherein
said rib member has one of a rounded or triangular shape.

6. A separator according to claim 1, wherein
said geometric feature extends from opposing surfaces of said segment.

7. A separator according to claim 5, wherein
said geometric feature has one of a generally circular or diamond cross-sectional shape.

8. A separator for a communication cable, comprising:
a body including,
a plurality of segments adapted to define a plurality of quadrants in the communication cable for separating wires, each of said segments having a terminal end, said segments meeting at a junction point of said body, and
each of said plurality of segments having at least one geometric feature, each of said geometric features being located between said junction point of said body and said terminal end of each of said segments, said geometric features having a geometric shape defining a discrete portion of each of said segments to form at least one reduced area of said body.

9. A separator according to claim 8, wherein
each of said geometric features is a rib member.

10. A separator according to claim 8, wherein
said plurality of segments form a cross web, thereby defining at least four quadrants in the communication cable; and
each of said segments having a plurality of said geometric features spaced from said terminal ends thereof, such that at least one geometric feature extends into at least one of said four quadrant.

11. A separator according to claim 8, wherein
each of said geometric features is a rib member.

12. A separator according to claim 11, wherein
said rib member has a shape that is one of rounded or triangular.

13. A separator according to claim 8, wherein
each of said geometric features extends from opposing surfaces of said respective segment.

14. A separator according to claim 13, wherein
each of said geometric features has one of a generally circular or generally diamond cross-sectional shape.

15. A separator according to claim 8, wherein
said geometric features extending from opposing surfaces of said segments being offset from one another.

16. A separator according to claim 8, wherein
at least one of said segments is offset from the remaining segments.

17. A separator according to claim 8, wherein
said body is a unitary one-piece member.

18. A communication cable, comprising:
a jacket;
a separator received in said jacket, said separator including,
a body having a plurality of segments adapted to define a plurality of quadrants within said jacket, each of said segments having a terminal end, said segments being substantially perpendicular with respect to one another, said plurality of segments meet at a junction point of said body, and
at least one geometric feature located between said terminal end of each of said segments and said junction point of said body, each of said geometric features having a geometric shape defining a discrete portion of each of said segments to form at least one reduced area of said body wherein at least one geometric feature extends into each of said quadrants; and
at least one wire pair supported in each of said quadrants.

19. A communication cable according to claim 18, wherein
said plurality of segments form a cross web, thereby defining at least four quadrants in the communication cable.

20. A communication cable according to claim 18, wherein
each of said geometric features is a rib member.

21. A communication cable according to claim 20, wherein
said rib member has a shape that is one of rounded or triangular.

22. A communication cable according to claim 18, wherein
said geometric features extend from opposing surfaces of each of said segments.

23. A communication cable according to claim 22, wherein
said geometric features extending from opposing surfaces of said segments have one of a generally circular or generally diamond cross-sectional shape.

24. A communication cable according to claim 22, wherein
said geometric features extending from opposing surfaces of said segments are offset from one another.

25. A communication cable according to claim 18, wherein
at least one of said segments is offset from the remaining segments.

26. A communication cable according to claim 18, wherein
each of said wire pairs is in direct contact with at least one of said geometric features.

27. A communication cable according to claim 18, wherein
said body of said separator is a unitary one-piece member.

28. A communication cable, comprising:
a jacket;
a separator received in said jacket, said separator including,
a body having at least one segment adapted to define at least first and second quadrants in the communication cable for separating wires, said at least one segment having at least one part with a first width, and
said at least one segment including at least one geometric feature spaced from a terminal end of said segment, said geometric feature having a geometric shape defining a discrete portion of said segment, said geometric feature having a second width larger than said first width of said segment, whereby the difference between said first and second widths represents at least one reduced area of said body; and
at least one wire pair supported in each of said first and second quadrants.
